(19) United States
(12) Patent Application Publication
(10) Pub. No.: US 2007/0265124 A1
(43) Pub. Date: Nov. 15, 2007

(54) Chain plate structure

(76) Inventor: Wen-pin Wang, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/430,004

(22) Filed: May 9, 2006

(51) Int. Cl. F16G 13/02

(52) U.S. Cl. 474/206

(57) ABSTRACT

A chain plate structure includes a boss protruding from a connecting hole of a connecting end of a chain plate. The boss has an injection beak corresponding to a notch of a bushing, so that lubricant can be injected into the chain plate through the notch and the injection beak to lubricate the chain for maintenance.

### BACKGROUND OF THE INVENTION

1. Field of the Invention

This invention relates to a chain plate structure, and more particularly to a chain plate having an injection beak and a notch on a connecting hole and a bushing, respectively, to facilitate injection of lubricant therein.

2. Description of the Prior Art

When a chain is assembled, the chain has to be soaked into a warmed lubricant, so that when the chain is picked up from the lubricant, it is wrapped with a thick layer of lubricant to provide the chain plate a smooth transition and to protect it from friction. However, the lubricant layer will be covered with dirt and dust and blocks the gap between chain plates.

Although we apply more lubricant on the chain plate later on, the dirt will be sticking with the chain, which prevents the lubricant from penetrating into the gaps.

As shows in FIG. 11, an inner bulge edge A1 of a chain plate A is embedded into a roller B, which has no gaps between the two parts, that blocks lubricant from penetrating through.

### SUMMARY OF THE INVENTION

It is the primary object of the present invention to provide a chain plate structure, which accumulates lubricant at an injection beak of a boss protruding from a chain plate and a notch of a bushing. The friction of the chain produces heat and dissolves the lubricant from sticking type to liquid that penetrates into a pin to minimize the friction.

It is another object of the present invention to provide a chain plate structure, which is easy to inject lubricant into the chain plate through the injection beak and the notch formed on the chain plate and the bushing, respectively.

It is a further object of the present invention to provide a chain plate structure, which can be injected lubricant into the chain to protect the chain plate from getting rusted easily.

It is still a further object of the present invention to provide a chain plate structure, which may be applied to various chain plates without downgrading its strength.

According to the present invention, there is provided a chain plate structure comprising a chain plate, a bushing and a pin; said chain plate comprising a first connecting end and a second connecting end escalating from said first connecting end, said first connecting end comprising a first connecting hole, said second connecting hole comprising a second connecting hole, every two chain plates forming a chain plate set, said first connecting end of one chain plate being attached onto said second connecting end of the other chain plate of each chain plate set; said bushing being located in between each chain plate set; said pin being inserted into said first connecting hole of said first connecting end and said second connecting hole of said second connecting end of each chain plate set; said second connecting hole of said second connecting end comprising a boss protruding from inside thereof, said boss comprising an injection beak, and said bushing comprising a notch corresponding to said injection beak of said boss.

### BRIEF DESCRIPTION OF THE DRAWINGS

FIG. 1 is an exploded view of a first embodiment of the present invention;

FIG. 2 is a perspective view of the first embodiment of the present invention;

FIG. 3 is a side view of the first embodiment of the present invention, partially sectioned;

FIG. 4 is a front sectional view of FIG. 2;

FIG. 5 is an exploded view of another design of the first embodiment of the present invention;

FIG. 6 is an exploded view of another design of the first embodiment of the present invention;

FIG. 7 is a further exploded view of another design of the first embodiment of the present invention;

FIG. 8 is still a further exploded view of another design of the first embodiment of the present invention;

FIG. 9 is an exploded view of a second embodiment of the present invention;

FIG. 10 is an exploded view of another design of the second embodiment of the present invention; and

FIG. 11 is a side cross sectional view of a chain plate of the prior art.

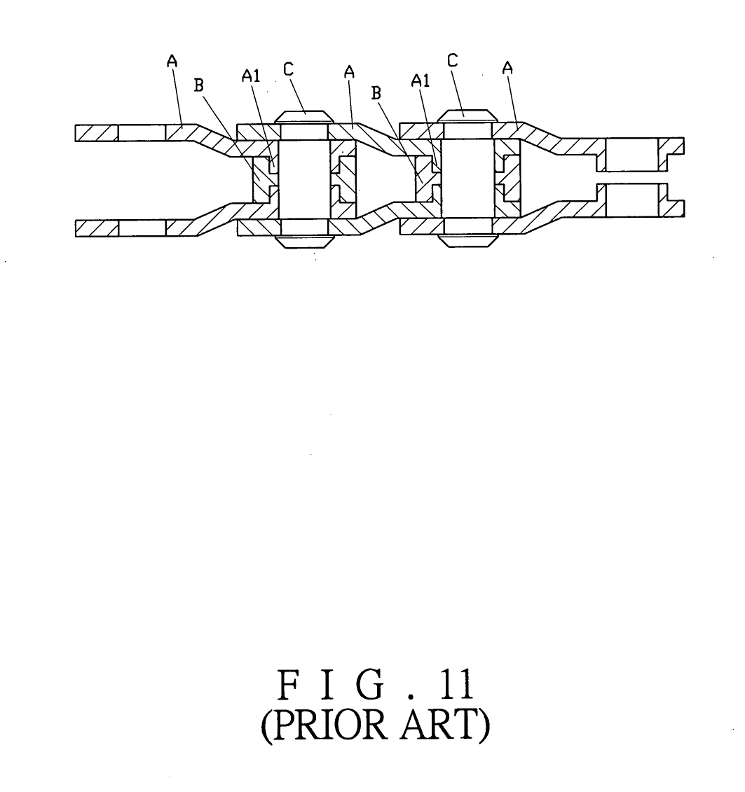

### DETAILED DESCRIPTION OF THE PREFERRED EMBODIMENTS

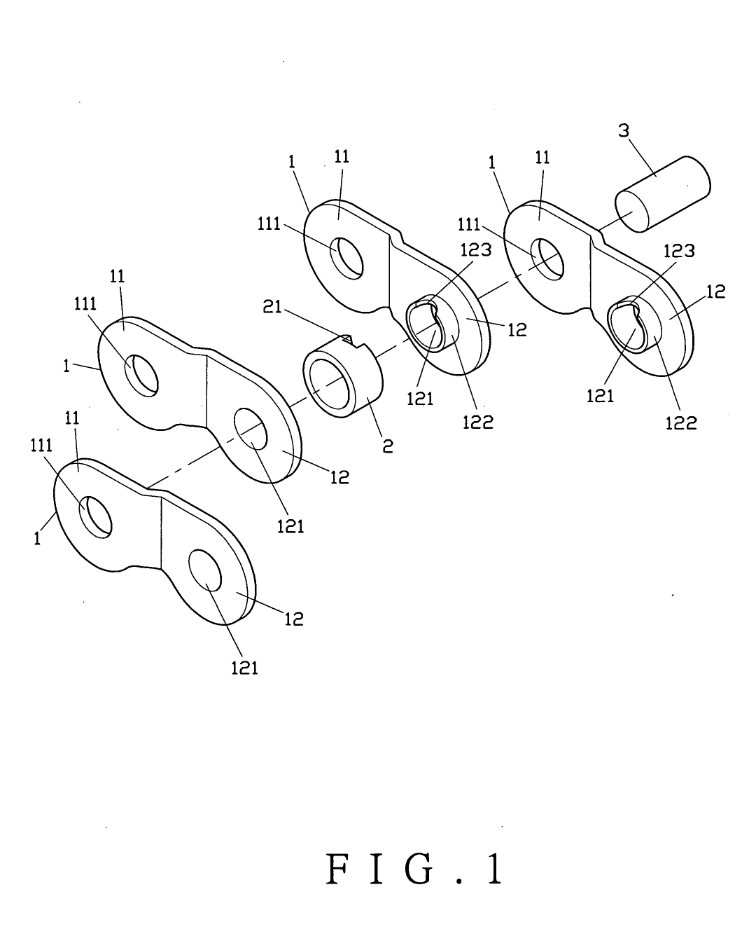

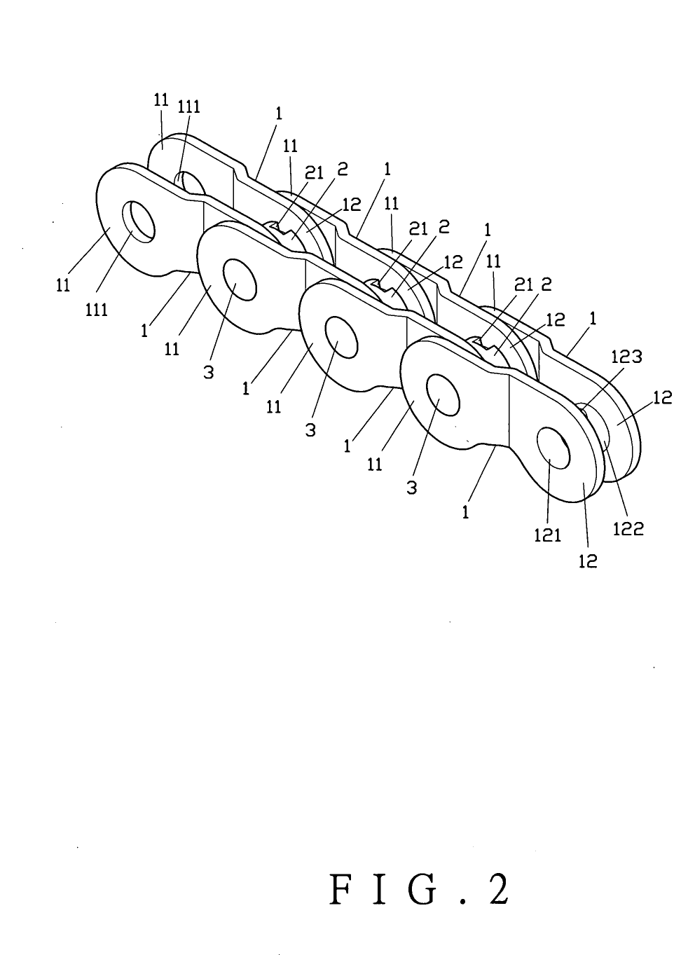

As shown in FIGS. 1 and 2, a first embodiment of the present invention comprises a chain plate 1, a bushing 2 and a pin 3.

The chain plate 1 comprises a first connecting end 11 and a second connecting end 12. The first connecting end 11 has a first connecting hole 111, and is divided with the second connecting end 12 by bending an angle at the center. The second connecting end 12 comprises a second connecting hole 121. Two chain plates 1 are formed in one set. The first connecting end 11 of one chain plate 1 is attached onto the outside of the second connecting end 12 of the other chain plate 1 of each chain plate set.

The bushing 2 is placed in between each chain plate set.

The pin 3 is inserted into the first connecting hole 111 and the second connecting hole 121 of each chain plate set.

The chain plate 1 has a boss 122 protruding from the second connecting hole 121 inwardly with an injection beak 123. The bushing 2 has a notch 21 corresponding to the injection beak 123 of the boss 122. The notch 21, as shown in FIG. 1, is a single design, which can be made in multiples.

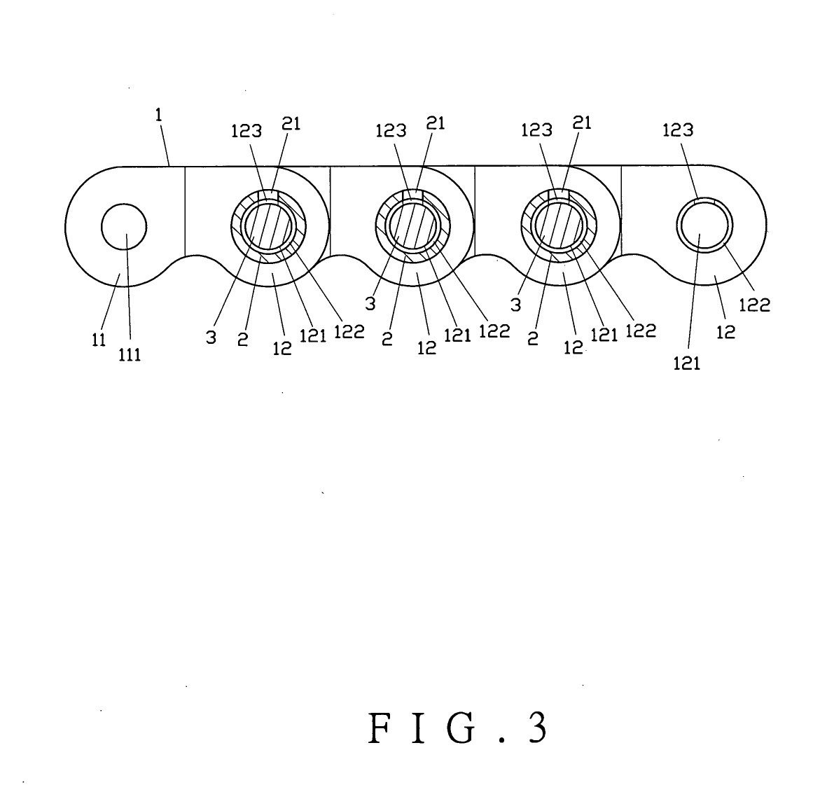

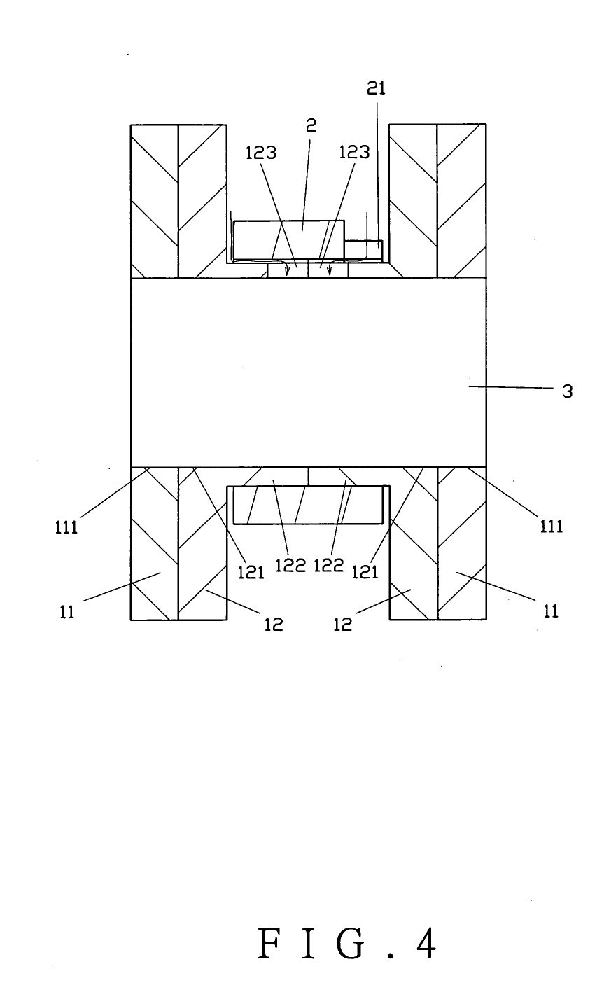

As shown in FIGS. 3 and 4, the chain plate 1 is soaked in a warmed liquid lubricant. The injection beak 123 of the boss 122 and the notch 21 of the bushing 2 will accumulate lubricant. Upon the temperature drops, the lubricant will be piled up in the injection beak 123 and the notch 21. After a certain time, the lubricant in the injection beak 123 and the notch 21 will disappear. The user may inject lubricant into the notch 21 of the bushing 2, and the lubricant flows through the gap between the bushing 2 and the chain plate 1 to the pin 3 so as to maintain the quantity of lubricant and to obtain the best quality of the chain plate 1.

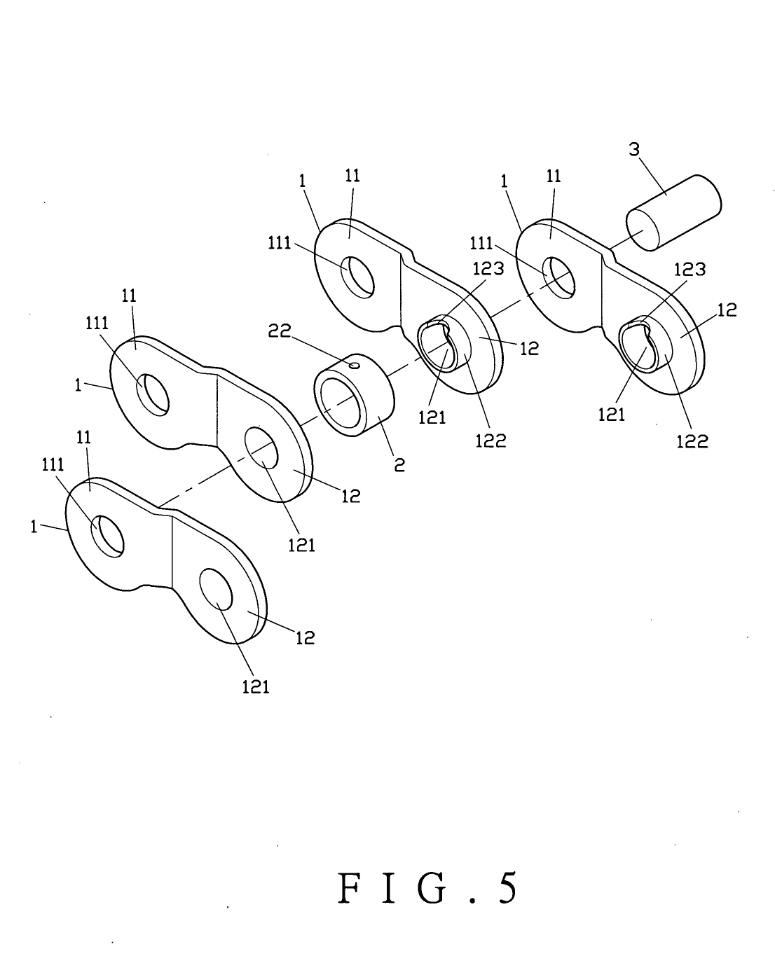

FIG. 5 shows another design of the first embodiment. The bushing 2 has a through hole 22 at the center corresponding to the injection beak 123 of the boss 122. The through hole 22 can be formed in multiple.

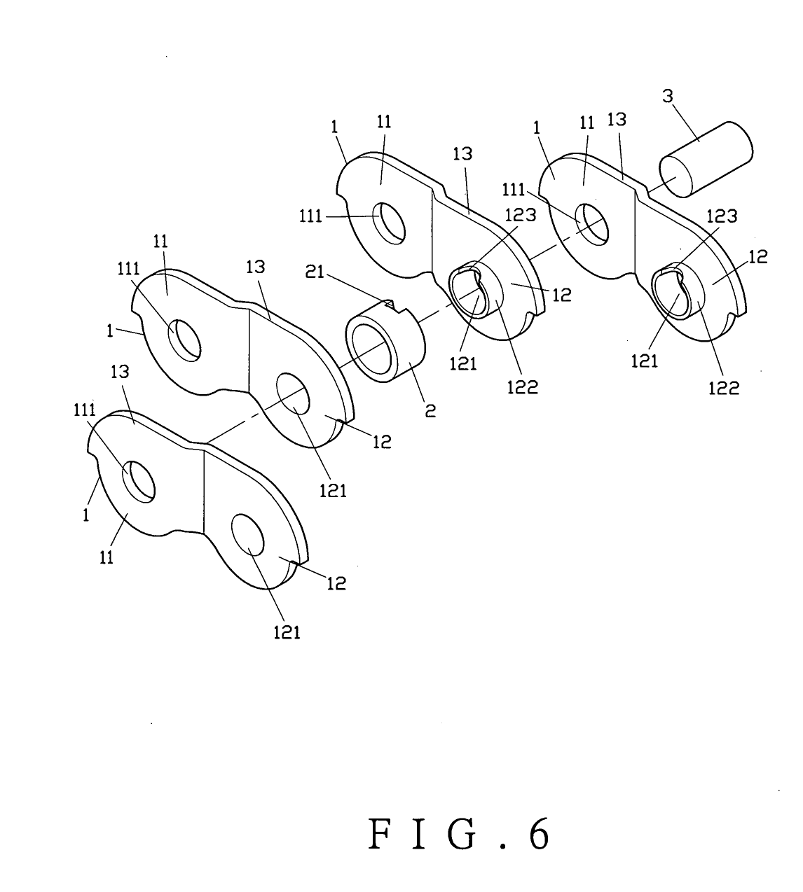

As shown in FIG. 6, the china plate 1 further comprises a protruding edge 13 on the top portion of the chain plate 1, which makes the top portion with a larger width than the bottom portion.

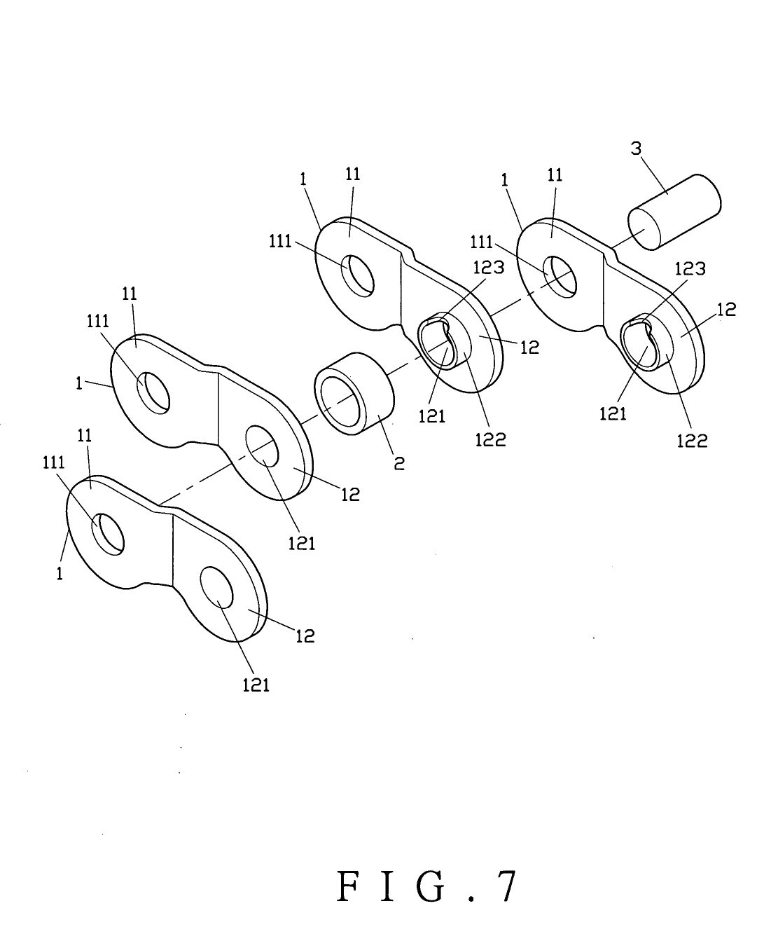

As shown in FIG. 7, the bushing 2 has a flat smooth surface. The lubricant is injected through the gap between the bushing 2 and the chain plate 1 and flows to the pin 3.

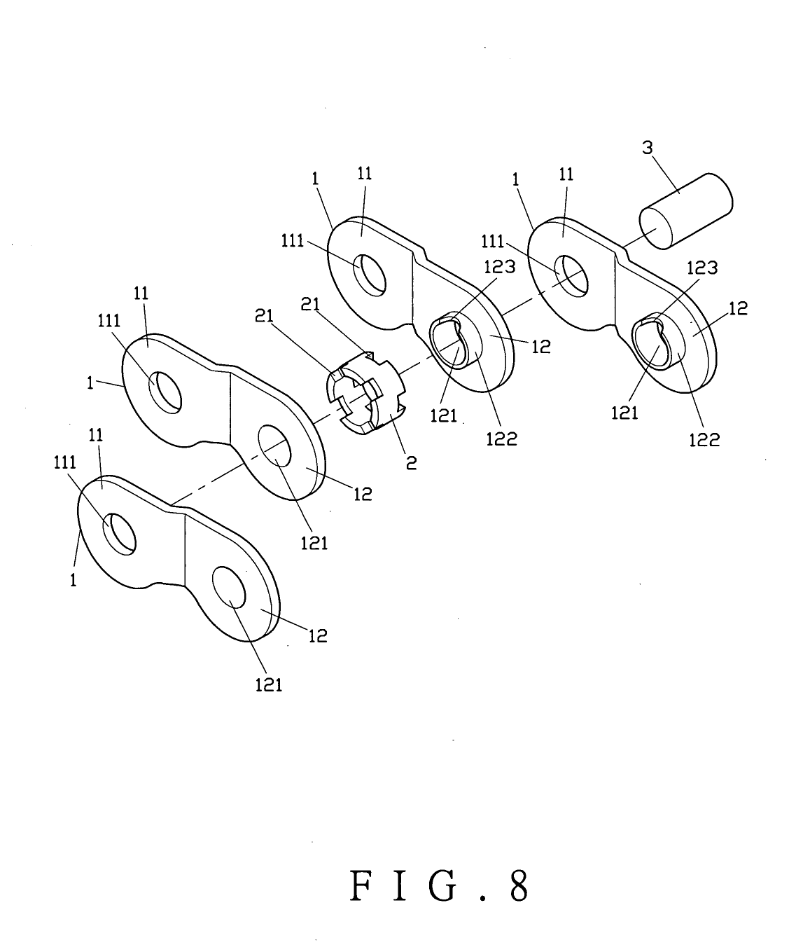

As shown in FIG. 8, the bushing 2 is formed with multiple notches 21 which are interlaced on both ends of the bushing 2.

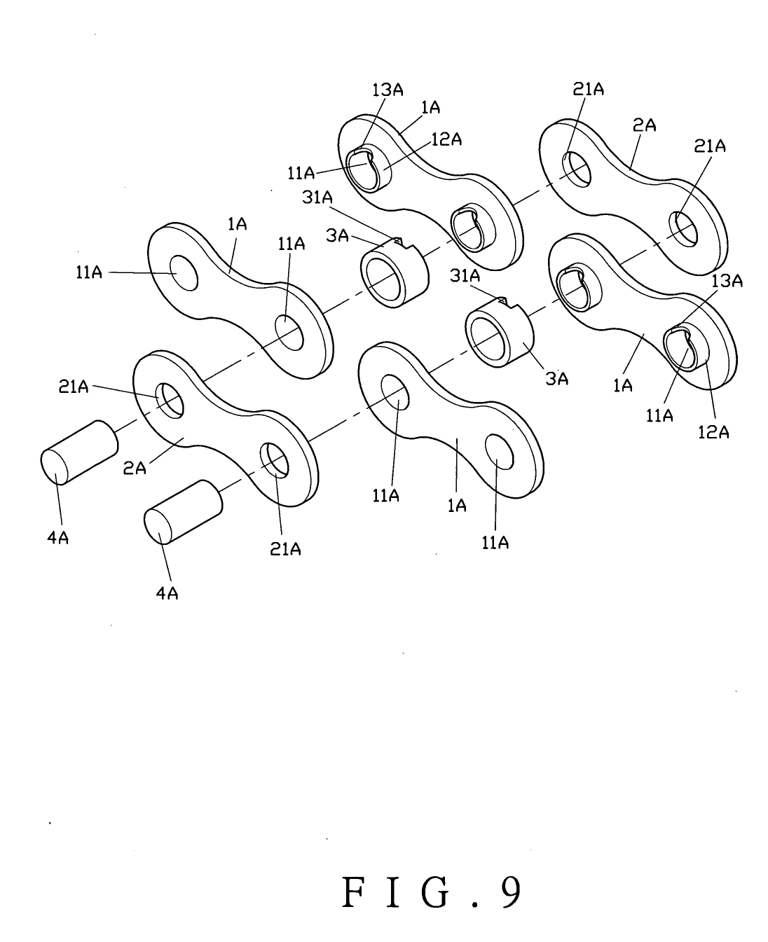

As shown in FIG. 9, a second embodiment of the present invention includes an inner chain plate 1A having first connecting holes 11A and an outer chain plate 2A having second connecting holes 21A. Two inner chain plates 1A form an inner chain plate set. Two inner chain plates 2A form an outer chain plate set. The second connecting holes 21A correspond to the first connecting holes 11A. A bushing 3A is placed in between a set of the inner chain plates 1A. A pin 4A is used to connect the second connecting hole 21A of the outer chain plate 2A and the first connecting hole 11A of the inner chain plate 1A next to each other. The first connecting hole 11A of the inner chain plate 1A is provided with a boss 12A having an injection beak 13A thereat. The bushing 3A has a notch 31A corresponding to the injection beak 13A of the boss 12A.

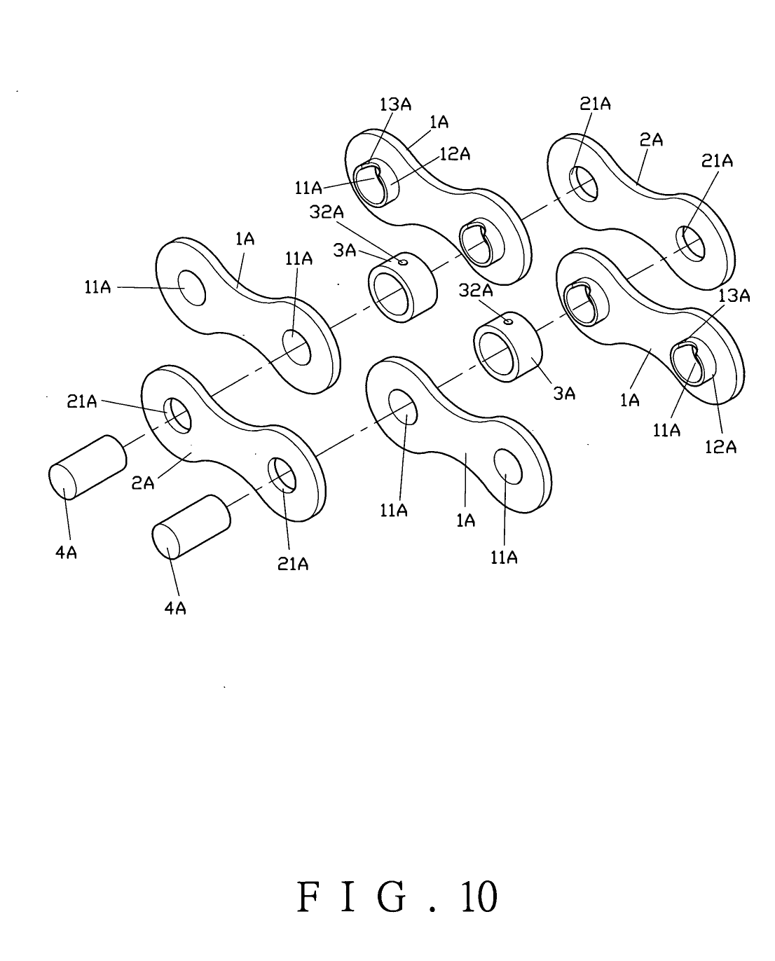

FIG. 10 shows another design of the second embodiment of the present invention, the bushing 3A is provided with a through hole 32A corresponding to the injection beak 13A of the boss 12A. The through hole 32A can be made in single or multiple number.

When the chain plates mesh with the disc, the injection beak 13A will be located opposite the meshing end, which sustains less pulling strength from the chain plate. Thus the injection beak 13A will not affect the structure strength, and is easy to inject lubricant therein.

What is claimed is:

1. A chain plate structure, comprising:
a chain plate, said chain plate comprising a first connecting end and a second connecting end escalating from said first connecting end, said first connecting end comprising a first connecting hole, said second connecting hole comprising a second connecting hole, every two chain plates forming a chain plate set, said first connecting end of one chain plate being attached onto said second connecting end of the other chain plate of each chain plate set;
a bushing, said bushing being located in between each chain plate set;
a pin, said pin being inserted into said first connecting hole of said first connecting end and said second connecting hole of said second connecting end of each chain plate set; and characterized by:
said second connecting hole of said second connecting end comprising a boss protruding from inside thereof, said boss comprising an injection beak, and said bushing comprising a notch corresponding to said injection beak of said boss.

2. The chain plate structure, as recited in claim 1, wherein said bushing comprises a through hole at a center portion corresponding to said injection beak of said boss.

3. A chain plate structure, comprising:
an inner chain plate having first connecting holes thereon, every two said inner chain plates forming an inner chain plate set;
an outer chain plate having second connecting holes, every two said outer chain plates forming an outer chain plate set disposed outside an adjacent inner chain plate set, said second connecting holes corresponding to said first connecting holes,
a bushing, said bushing being located in between each inner chain plate set;
a pin, said pin being inserted into said second connecting hole of said outer chain plate and said first connecting hole of an adjacent inner chain plate; and characterized by:
each said first connecting hole of said inner chain plate comprising a boss protruding from inside thereof, said boss comprising an injection beak, and said bushing comprising a notch corresponding to said injection beak of said boss.

4. The chain plate structure, as recited in claim 3, wherein said bushing comprises a through hole at a center portion corresponding to said injection beak of said boss.
